(19) United States
(12) Patent Application Publication
(10) Pub. No.: US 2016/0203518 A1
(43) Pub. Date: Jul. 14, 2016

(54) DYNAMIC PHOTO AND MESSAGE ALTERATION BASED ON GEOLOCATION

(71) Applicant: Life Impact Solutions, LLC, Irvine, CA (US)

(72) Inventor: Aaron Horvath, Ladera Ranch, CA (US)

(21) Appl. No.: 14/804,075

(22) Filed: Jul. 20, 2015

Related U.S. Application Data
(60) Provisional application No. 62/028,764, filed on Jul. 24, 2014.

(51) Int. Cl. G06Q 30/02; H04L 12/58; H04L 29/08; G06Q 50/00; H04W 4/02

(52) U.S. Cl. CPC G06Q 30/0259; G06Q 30/0276; G06Q 50/01; H04W 4/023; H04L 67/306; H04L 51/20; H04L 51/32

(57) ABSTRACT

A geographic location based content editing system to advertise a business through a social media network. A business organization registers in the system by providing a plurality of business elements therein. A user selects a photo, video or message stored in a communication device installed with the content altering software application. If the geographic location of the user is within a business geographic location of the business organization, then the content selected by the user is altered by including at least one of the plurality of business elements like logos and special offers thereby generating a branded advertising message. This branded advertising message is then shared on the social media network through a user account of the user. The business organization provides rewards to the user for sharing business logos and photos on the social media network.

### BACKGROUND OF THE DISCLOSURE

1. Technical Field of the Disclosure

The present embodiment relates generally to branded advertising and messaging, and more particularly, to a system and method for performing a social media based content editing process based on the geographic location of a user and a business organization.

2. Description of the Related Art

Social media based advertisement methods have become a common means for businesses to expand their presence for the digital age. The advantage of these advertisement methods is the capability to reach people who are interested in specific products or services. However, conventional social media based advertisement methods have considerable drawbacks. Typically, businesses and companies advertise their products or services based on relevant content. It is expensive for businesses to purchase and place branded content like photos and messages on popular social media platforms (e.g., Facebook®, Instagram®, Twitter®, etc.). Today, companies need to pay more for branded advertising and messaging to appear in social media activity feeds. This is costly and slower than the flow of information which is provided by social media users and those who consume content posted by other users.

Additionally, these paid branded messages are not always relevant. For example, a company located in a particular city may not benefit if branded advertising and messages are placed in social media feeds related to users who travel to a variety of different locations. On the other hand, some users can check-in to a location, which helps businesses acquire greater exposure.

Several methods have been developed to enhance the advertisement process through social media networks. For example, one method describes an apparatus that includes a photograph identification module, a photograph analysis module, a correspondence module, and an advertisement module. The photograph identification module identifies one or more photographs corresponding to a user of a social networking network. However, this method is not based on the geographic location of the user, the location of the user relative to the business, nor the location of the business that is advertising. Therefore, the method does not help the business acquire the desired exposure.

Another method describes a process for analyzing information from social media networks and provides advertisements based on this information. Social media networks are analyzed to determine topics of conversation and, for particular users, areas of interest, levels of expertise, and areas of influence over other users. User information, content, and relationships may be analyzed across different social media networks which match users on different social media networks to a single actual person thereby obtaining additional information about that person. However, this method is fairly costly.

Yet another method describes a method and apparatus for improving word-of-mouth online advertising. This method constructs a social network including multiple users based on the users' social network data and optionally further based on the users' demographical and/or other personal information. The method categorizes the users in the social network with respect to a type of product in terms of their propensity to adopt the type of product as well as influence others in the social network to adopt the type of product. However, this method is not cost effective.

Therefore, there is a need for a method that would allow users to dynamically generate their own photos, messages, and videos which in essence serve as advertisements for a business. Such a method and related device would allow users to view, save, and post their own content via social media, thus serves as branded advertisements for a business. Such a device would reward the users for sharing business logos, messages, and photos on social media networks. Further, such a needed device would provide the capability for advertisements based on the geographic location of a user and a business. Moreover, such a device would be more cost effective for businesses to acquire needed exposure on social media networks. The present embodiment accomplishes these objectives.

### SUMMARY OF THE DISCLOSURE

To minimize the limitations found in the prior art, and to minimize other limitations that will be apparent upon the reading of this specification, the preferred embodiment of the present invention provides a geographic location based content editing system an end user to advertise a brand, location, product or an event associated with a business organization on a social media network. The geographic location based content editing system includes a central computer having a processor installed with a content altering software application and coupled with a memory unit integrated with a central database. The present system allows the business organization to advertise its business through their customers by superimposing: the business brand name, an event, or location associated with the business on a photo, message, video/audio clip and/or photo album taken by the customer/user.

The method starts by enabling the business organization to register the geographic location based content editing system. The business organization registers with any electronic device including but not limited to a laptop, a personal computer, a smart phone, a tablet computing device or a hand-held digital media communication device. The business organization provides information regarding a plurality of business elements to the geographic location based content editing system while registering. The plurality of business elements includes the name of the business organization, business address, a contact number of the business organization, an email address associated with the business organization, a business logo, at least one business photo, at least one primary color associated with the business, at least one secondary color associated with the business and at least one special offer from the business organization. The provided business elements are stored in the central database via the internet.

In one embodiment of the present invention, the user of the present system has an account with the social media network like Facebook, Twitter and/or Instagram. Preferably, the user is a customer of the business organization. In the preferred embodiment, the user utilizes a communication device to share the photos, messages, and videos altered with a business logo or any content associated with the business organization. The communication device may be a smart phone, a laptop, a personal computer or any other suitable portable communication device. The content altering software application adaptable to alter photos, messages and videos is installed on the communication device.

In one aspect of the preferred embodiment, the communication device is a mobile computing device. In this case, the second communication device communicates with the central database via a network. The network may be the internet or a mobile communication network.

When the user wishes to upload the content on the social media network, the user selects the content such as a photo, video clip or message from the mobile computing device. In the preferred embodiment, the user captures a photo or video or creates a message using a smartphone at the location of the business. At the same instant of the photo capture, the content altering software application checks if the geographic location of the user is within or near to the geographic location of the business organization utilizing a geographic location determination service installed on the mobile computing device. The geographic location determination service may be a global positioning system (GPS), may be based off known wireless hotspot locations, or may be a manual search process. If the business organization is not within the user's location, then the system shares the selected photo or message on the social media network without alteration. If the business organization is nearby or at the user location, then the system checks if the business organization is registered in the central database utilizing the content altering software application. If the business organization is registered at the central database, then the system retrieves at least one of the plurality of business elements from the central database utilizing an interface program. The interface program is an application programming interface (API) or an operating system layer having direct access to the central database. If the business organization is a registered member then utilizing the content altering software application, the user dynamically alters the photo, video or message selected by the user by including the at least one of the plurality of business elements such as logo, brands, and special offers in the captured photo to create a branded advertisement message. Thus, the branded advertisement message may include business logos, colors, photos, and contact information based on the business' geographic location.

If the business organization is not registered at the central database, then the user may share the selected photo or message without alteration on the social media network. In another aspect of the present invention, the user selects a photo, any message or video stored on their device's photo gallery which is captured from a prior time.

Upon alteration, the user shares the branded message on the user's account on the social media network. The content altering software application enables the business organization to in essence advertise the business utilizing the user's account on the social media network. In another embodiment of the present invention, the user shares the branded advertisement message through the social media network and any private messaging channel such text messaging, instant messaging, short message service (SMS) or e-mail. The content altering software application uses application programming interfaces (APIs) to share/upload the select photos and messages to social media networks. In one aspect of the preferred embodiment, the geographic location based content editing system provides rewards, which are optionally redeemable, to the users on sharing these branded photos, messages and/or videos.

A first objective of the present invention is to provide a method that dynamically generates branded photos and messages and uploads the branded content to a social media network.

A second objective of the present invention is to generate branded content based on the geographic location of a user and a business organization.

A third objective of the present invention is to leverage customers to provide greater exposure on social media networks to the business organizations without paying for traditional advertising media.

A fourth objective of the present invention is to allow the business organization to provide rewards to the user for creating and sharing on the social network, content such as photos, messages and videos associated with the business.

These and other advantages and features of the present invention are described with specificity so as to make the present invention understandable to one of ordinary skill in the art.

### BRIEF DESCRIPTION OF THE DRAWINGS

FIG. 1 is a high level block diagram of a geographic location based content editing system for promoting a business on a social media network according to the preferred embodiment of the present invention; and

FIGS. 2A and 2B illustrate a flowchart of a method for performing geographic location based content editing utilizing the geographic location based content editing system to advertise the business on the social media network.

### DETAILED DESCRIPTION OF THE DRAWINGS

In the following discussion that addresses a number of embodiments and applications of the present invention, reference is made to the accompanying drawings that form a part hereof, and in which is shown by way of illustrating specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below. The invention will now be described with reference to the accompanying drawing which does not limit the scope and the ambit of the invention.

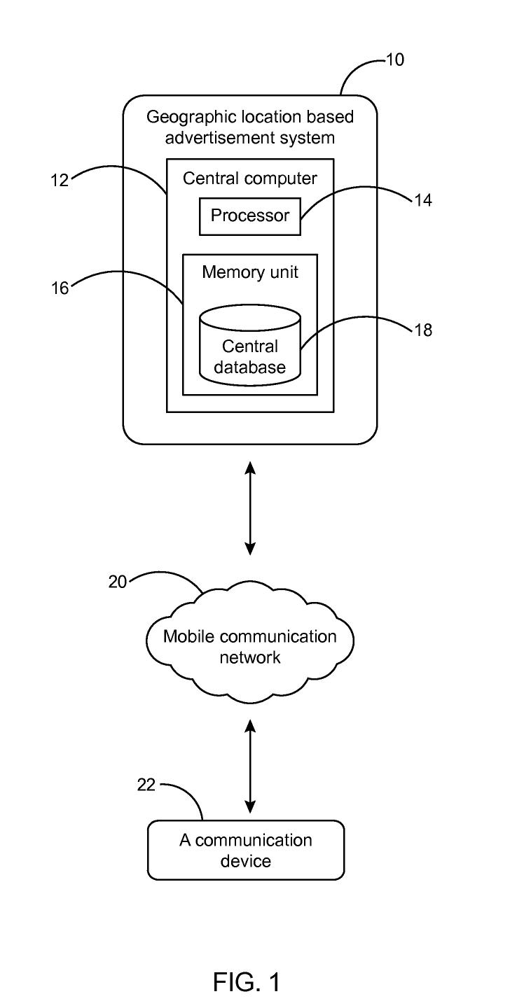

Turning first to FIG. 1, a high level block diagram of a geographic location based content editing system 10 for advertising business brands, logos, special offers or locations on a social media network in accordance with an embodiment of the present invention is illustrated. The geographic location based content editing system 10 enables a business organization to advertise its business products, brands, location or an event through their customers. In the preferred embodiment, the geographic location based content editing system 10 resides on a central computer 12 having a processor 14 on which a content altering software application is installed and coupled with a memory unit 16 integrated with a central database 18. The content altering software application may be a mobile application, a desktop computer application, an embedded software program, or any other type of software application that runs on the processor 14 of the central computer 12. In one embodiment of the present invention, the central computer 12 is a server system.

In order to avail the service of the geographic location based content editing system 10, the business organization should be a registered member in the geographic location based content editing system. The business organization may register with the system using a computer or any mobile phone. Preferably, the business organization provides information regarding a plurality of business elements for registering with the system 10. The plurality of business elements may include but is not limited to the name of the business organization, address of the business organization, a contact number of the business organization, an email address associated with the business organization, a business logo, at least one business photo, at least one primary color associated with the business, at least one secondary color associated with the business, and at least one special offer from the business organization. The provided business elements are stored in the central database 18 via the internet 20. Preferably, the user is a customer of the business organization.

In one aspect of the preferred embodiment and as shown in FIG. 1, the user communicates with the system 10 via a communication device 22 on which the content altering software application is installed. The communication device 22 is a mobile computing device such a smart phone, tablet computer, or other suitable mobile device. In this case, the communication device 22 communicates with the central database via network 20 such as the internet or a mobile communication network. In one embodiment, the content altering software application is a mobile application.

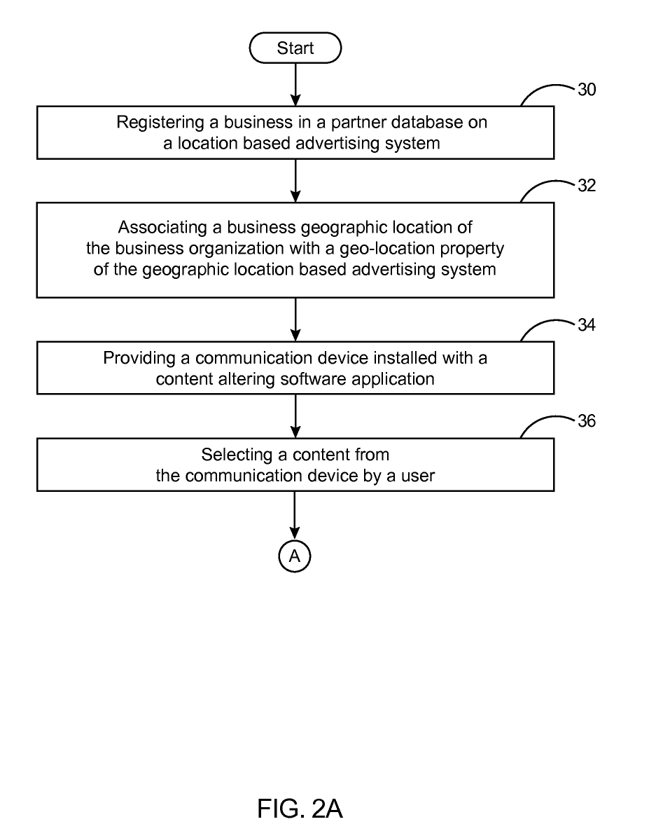

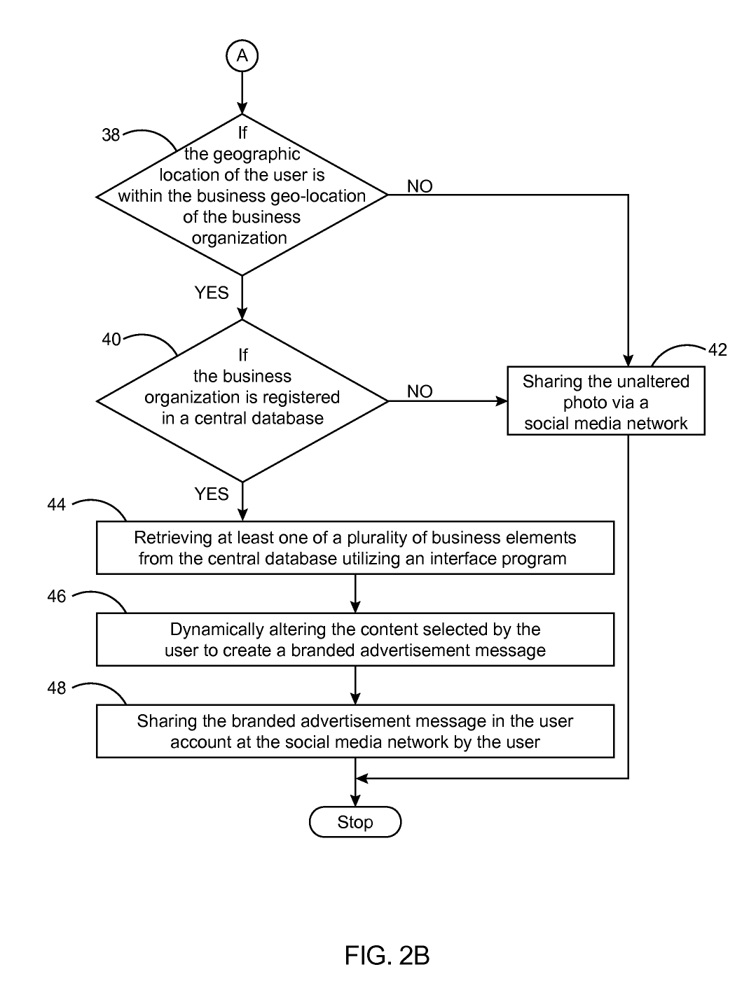

As shown in FIGS. 2A and 2B, the method for performing the geographic location based content editing is illustrated. The method commences by registering the business organization in the geographic location based content editing system as shown in block 30. The business organization associates a business geographic location with a geo-location property of the geographic location based content editing system as shown in block 32. The mobile computing device of the user has the content altering software application installed as indicated at block 34.

When the user desires to upload content such as a photo, video or message in a social media network like Facebook, Twitter or Instagram, the user selects the content from the mobile computing device as shown in block 36. In order to perform this step, the user captures a photo or video or creates a message using a smart phone or any mobile computing device from the location of the business organization in real time. In another aspect of the present invention, the user selects and uses a photo or video which was captured at a prior time or was received from a third party or downloaded from other systems.

Next, the system checks if the geographic location of the user is within or near the business geographic location of the business organization utilizing a geographic location determination service implemented at the mobile computing device as shown in block 38. The geographic location determination service may be a global positioning system (GPS) or a manual search process. The GPS service automatically identifies the user's current location and displays the business organization which is located near or at the same location of the user.

If the business organization is not at the geographic location of the user then the user shares the selected photo, video or message without any alteration on the social media network as indicated at block 42, and the geographic location based advertising method terminates. If the business organization is nearby or at the user location, then the user checks if the business organization is registered in the central database utilizing the content altering software application as shown in block 40. If the business organization is a registered member on the central database, then the mobile computing device retrieves at least one of the plurality of business elements from the central database utilizing an interface program installed on the mobile computing device as shown in block 44. The interface program is an application programming interface (API) or an operating system layer having direct access to the central database. If the business organization is a registered member then the system dynamically alters the content by including at least one of the business' plurality elements in the content utilizing the content altering software application. This creates a branded advertisement message as shown in block 46. In one embodiment of the present invention, the content altering software application alters the selected content by superimposing business information like a business logo, message regarding any special offer on a top or bottom margin of the photo or message selected by the user. If the business organization is not registered in the central database then the user shares the selected photo or message on the social media network without alteration as indicated at block 42. In one embodiment of the present invention, the system 10 is designed to display a pop up window conveying to the user that the particular business organization is not registered in the central database.

Upon alteration, the user shares the branded advertisement message on their user account with the social media network as indicated at block 48. The content altering software application enables the business organization to advertise the business utilizing the user's account on the social media network. In another embodiment of the present invention, the user shares the branded advertisement message through the social media network and any private messaging channel like text messaging, short message service (SMS) or e-mail. When other users view the altered photo, the unique branding, messaging, and special offer(s) of the business organization, said items are displayed in relation to the geographic location.

In another aspect of the geographic location based content editing system and method, the user is rewarded for the creation of the content. Here, for creating branded photos, messages and/or videos on the social network, the user may be rewarded through such rewards as gift vouchers, points to use on within other systems, opportunities to win prizes, special discounts or virtual prizes for various products and services both tangible and intangible. The information regarding the reward is stored in the central database of the system. As one specific example, if the user were to capture a photo or video from a specific car dealership, then the content altering software application would be capable of altering the user's content by superimposing the business logo or information regarding any special offer from the car dealership over the content. Thereafter, the user may be provided with a reward, for example a free gas card to be used for the purchase of gasoline.

The content altering software application may be developed in terms of four main areas of engineering associated with a software architecture to facilitate the method for performing advertisement based on the geographic location of the user and the business organization. These four areas are described below:

What is claimed is:

1. A geographic location based content editing system to allow a user to create and share information regarding a business on at least one social media network, the geographic location based content editing system residing on a central computer having a processor installed with a content altering software application and coupled with a memory unit integrated with a central database, the processor being configured to:
enable at least one business organization to register in the geographic location based content editing system by providing a plurality of business elements therein, the business organization accesses the central database of the geographic location based content editing system to provide the plurality of business elements, the plurality of business elements stored in the central database via a network;
enable the business organization to associate a business geographic location of the business organization with a geo-location property of the geographic location based content editing system;
enable a user to select a content stored in a communication device of the user, the communication device being installed with the content altering software application, the user holds a user account on the social media network, the communication device being connected with the central database via the Internet or mobile communication network;
enable the content altering software application to check if the geographic location of the user is near or at a registered location in the central database using a geo-location determination service implemented on the communication device;
allow the content altering software application to check if the business geographic location is registered at the central database based on the geographic location of the user;
enable the content altering software application to retrieve at least one of the plurality of business elements from the central database utilizing an interface program if the business organization is registered in the central database;
dynamically alter the content selected by the user using the at least one of the plurality of business elements in the content thereby creating a branded advertisement message utilizing the content altering software application; and
enable the user to share the branded advertisement message on the user account at the social media network;
whereby the content altering software application enables the business organization to advertise the business utilizing the user account on the social media network.

2. The geographic location based content editing system of claim 1 wherein the communication device is selected from a group consisting of: a smart phone, a laptop, a personal computer, a tablet computing device and a hand-held digital media communication device.

3. The geographic location based content editing system of claim 1 wherein the plurality of business elements is selected from a group that may include but not limited to: name of the business organization, address of the business organization, a contact number of the business organization, an email address associated with the business organization, a business logo, at least one business photo, at least one primary color associated with the business, at least one secondary color associated with the business and at least one special offer from the business organization.

4. The geographic location based content editing system of claim 1 wherein the content is selected from a group consisting of: an image, video and a message.

5. The geographic location based content editing system of claim 4 wherein the image selected by the user is captured from the geographic location of the user at real time.

6. The geographic location based content editing system of claim 4 wherein the image selected by the user is captured in a prior time.

7. The geographic location based content editing system of claim 1 wherein the geographic location determination service is a global positioning system (GPS).

8. The geographic location based content editing system of claim 1 wherein the geographic location determination service is a manual search process.

9. The geographic location based content editing system of claim 1 wherein the interface program is an application programming interface (API) having direct access to the central database.

10. The geographic location based content editing system of claim 1 wherein the interface program is an operating system layer having direct access to the central database.

11. The geographic location based content editing system of claim 1 wherein the system allows the business organization to provide a reward to the user for sharing the at least one of the plurality of business elements in the social media network.

12. A method for performing a geographic location based advertising utilizing a geographic location based content editing system to advertise a business on at least one social media network, the geographic location based content editing system resides on a central computer having a processor installed with a content altering software application and coupled with a memory unit integrated with a central database, the method comprising the steps of:
a) registering at least one business organization on the geographic location based advertisement system by providing a plurality of business elements therein, the business organization being registered in the central database of the advertisement system, the plurality of business elements stored in the central database via a network;
b) associating a business geographic location with a geo-location property of the geographic location based content editing system;
c) selecting a content stored at a communication device of a user, the communication device is installed with the content altering software application, the user holds a user account on the social media network, the communication device being connected with the central database at the central computer via the network;
d) checking if the geographic location of the user being within the business geographic location of the business organization by the content altering software application utilizing a geo-location determination service implemented at the communication device;
e) checking if the business organization is registered in the central database by the content altering software application if the business organization being within the geographic location of the user;
f) retrieving at least one of the plurality of business elements from the central database utilizing an interface program by the content altering software application if the business organization being registered in the central database;
g) dynamically altering the content by including the at least one of the plurality of business elements in the content thereby creating a branded advertisement message utilizing the content altering software application; and
h) sharing the branded advertisement message in the user account at the social media network by the user;
whereby the content altering software application enables the business organization to advertise the business utilizing the user account on the social media network.

13. The method of claim 12 wherein the communication device is selected from a group consisting of: a laptop, a personal computer, a smart phone, a tablet computing device and a hand-held digital media communication device.

14. The method of claim 12 wherein the plurality of business elements is selected from a group that may include but is not limited to consisting of: name of the business organization, address of the business organization, a contact number of the business organization, an email address associated with the business organization, a business logo, at least one business photo, at least one primary color associated with the business, at least one secondary color associated with the business and at least one special offer from the business organization.

15. The method of claim 12 wherein the content is selected from a group consisting of: an image and a message.

16. The method of claim 12 wherein the geographic location determination service is a global positioning system (GPS).

17. The method of claim 12 wherein the geographic location determination service is a manual search process.

18. The method of claim 12 wherein the interface program is an application programming interface (API) having direct access to the central database.

19. The method of claim 12 wherein the interface program is an operating system layer having direct access to the central database.

20. A non-transitory computer-readable medium having computer-readable program code embodied therein which when executed by a computer having a processor installed with a content altering software application and coupled with a memory unit integrated with a central database causes the processor to perform the following steps:
a) registering at least one business organization on the geographic location based advertisement system by providing a plurality of business elements therein, the business organization accesses the central database of the geographic location based content editing system to provide the plurality of business elements stored in the central database via a network;
b) associating at least one business geographic location of the at least one business organization with a geo-location property of the geographic location based content editing system utilizing a first communication device;
c) selecting at least one content stored at a communication device of a user, the communication device being installed with the content altering software application, the user holds a user account on the social media network, the second communication device being connected with the central database via the Internet or a mobile communication network;
d) checking if the geographic location of the user is near or at a registered location in the central database using a geo-location determination service implemented at the communication device;
e) checking if the business location is registered in the central database based on the geographic location of the user;
f) retrieving at least one of the plurality of business elements from the central database utilizing an interface program by the content altering software application if the business organization is registered in the central database;
g) dynamically altering the content selected by the user using the at least one of the plurality of business elements in the content thereby creating a branded advertisement message utilizing the content altering software application; and
h) sharing the branded advertisement message in the user account at the social media network by the user;
whereby the content altering software application enables the business organization to advertise the business utilizing the user account on the social media network.

21. The non-transitory computer-readable medium of claim 20 wherein the communication device is selected from a group consisting of: a laptop, a personal computer, a smart phone, a tablet computing device and a hand-held digital media communication device.

22. The non-transitory computer-readable medium of claim 20 wherein the plurality of business elements is selected from a group that may include but not limited to consisting of: name of the business organization, address of the business organization, a contact number of the business organization, an email address associated with the business organization, a business logo, at least one business photo, at least one primary color associated with the business, at least one secondary color associated with the business and at least one special offer from the business organization.

23. The non-transitory computer-readable medium of claim 20 wherein the content is selected from a group consisting of: an image and a message.

24. The non-transitory computer-readable medium of claim 20 wherein the geographic location determination service is a global positioning system (GPS).

25. The non-transitory computer-readable medium of claim 20 wherein the geographic location determination service is a manual search process.

26. The non-transitory computer-readable medium of claim 20 wherein the interface program is an application programming interface (API) having direct access to the central database.

27. The non-transitory computer-readable medium of claim 20 wherein the interface program is an operating system layer having direct access to the central database.

28. The non-transitory computer-readable medium of claim 20 wherein the selected by the user is shared on the social media network without any alteration process if the business organization is not registered at the central database.

29. The non-transitory computer-readable medium of claim 20 wherein the business organization provides rewards to the user for sharing business logos and photos on the social media network.
